(19) United States
(12) Patent Application Publication
(10) Pub. No.: US 2016/0114844 A1
(43) Pub. Date: Apr. 28, 2016

(54) RETRACTABLE TRAILER APPARATUS

(71) Applicant: RONALD D. HARRIS, Meriden, CT (US)

(72) Inventor: RONALD D. HARRIS, Meriden, CT (US)

(21) Appl. No.: 14/923,838

(22) Filed: Oct. 27, 2015

Related U.S. Application Data
(60) Provisional application No. 62/069,645, filed on Oct. 28, 2014.

(51) Int. Cl. B62D 63/06; B62D 53/08

(52) U.S. Cl. CPC B62D 63/061; B62D 53/08

(57) ABSTRACT

A semi-trailer includes a parallelpiped shaped van having front and rear axially elongated parallelepiped shaped modules. The front axially elongated parallelepiped module is dimensioned and configured for telescoping axial movement with respect to the rear axially elongated parallelepiped module to vary the overall length of the trailer.

### CROSS-REFERENCE TO RELATED APPLICATIONS

This application relies on the priority of U.S. provisional patent application 62/069,645 filed by the applicant herein on Oct. 28, 2014.

### TECHNICAL FIELD

The present invention is generally directed to vehicles used by the trucking industry. More particularly, the present invention is directed to the trailer portion of what is often called an “18 wheeler”. That name is derived from the number of tires utilized by a typical over the road tractor trailer configuration. The term “semi-truck” is used in the trucking industry to describe an articulated (jointed) combination vehicle, often composed of a six-wheeled (three axle) tractor coupled by a “fifth wheel” to a four-wheeled (two axle) trailer. There are also two axle tractors, single axle trailers and occasionally combinations with the extra lift axles. Even more particularly, the present invention is directed to the enclosed trailer portion referred to as a dry van, van or box trailer of such articulated vehicles.

### BACKGROUND OF THE INVENTION

Operating an 18 wheeler in an urban environment can be very difficult because the semi-truck inherently has a very large turning radius. A typical trailer is 53 feet long. Accordingly the operation on urban streets which are relatively narrow and often have substantial traffic presents safety concerns as well as the inherent operational problems of maneuvering in congested areas.

From the above, it is therefore seen that there exists a need in the art to overcome the deficiencies and limitations described herein and above.

### SUMMARY OF THE INVENTION

The shortcomings of the prior art are overcome and additional advantages are provided through a semi-trailer for use with an associated tractor which includes a parallelpiped shaped van having front and rear axially elongated parallelepiped shaped modules. The rear axially elongated parallelepiped shaped module has a generally planar first and second spaced opposed sides, a generally planar top and a generally planar bottom disposed in spaced opposed relationship, and running gear comprising a plurality of rotatably mounted wheels fixed thereto. The front axially elongated parallelepiped module has generally parallel planar first and second spaced opposed sides, a generally planar top and a generally planar bottom disposed in spaced opposed relationship, and a planar front disposed in generally perpendicular relationship to and engaging said first and second spaced opposed sides as well as said top and bottom, said front axially elongated parallelepiped module being dimensioned and configured for telescoping axial movement with respect to said rear axially elongated parallelepiped module between a first position in which the overall length of the telescoping first and second axially elongated parallelepiped modules is a first dimension and a second position wherein the overall length of the telescoping first and second axially elongated parallelepiped modules is a second dimension that is greater then said first dimension, said front axially elongated parallelepiped module including a king pin for engaging an associated fifth wheel on an associated tractor.

In some embodiments of the present invention the semi-trailer a kingpin that is disposed proximate to a part of said front module that is most remote from said rear module. Some embodiments have a front module that is dimensioned to telescope within said rear module. Embodiments include a display indicating the relative positions of said first and second modules.

The semi-trailer may further include a plurality of locking pins dimensioned and configured for engaging the first and second modules simultaneously whereby the relative positions of the first and second modules will not change.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a schematic side view of a front module and a rear module in accordance with one embodiment of the present invention,

FIG. 2A is a schematic front view of one form of the front module,

FIG. 2B is a more detailed schematic side view of one form of the front and rear modules,

FIG. 3 is a schematic top view of one aspect portions of the front and rear module better illustrating the engagement therebetween,

FIG. 4 is a schematic sectional view looking down from a horizontal plane parallel to the floors of the modulus of one aspect portions of the front and rear module better illustrating the engagement therebetween,

FIG. 5A is a schematic side view of one form of the present invention with the front module fully extended from the rear module to provide a trailer that is 53 feet long,

FIG. 5B is a schematic side view of one form of the present invention with the front back module partially retracted 4 feet into the rear module to provide a trailer that is 45 feet long,

FIG. 5C is a schematic side view of one form of the present invention with the front back module fully retracted into the rear module to provide a trailer that is 32 feet long,

FIG. 6 is a partially schematic view illustrating the structure utilized in some embodiments of the present invention to prevent hose and cable connections between the respective modules from dragging on the ground,

FIG. 7 is a schematic view illustrating a ramp structure in accordance with one form of the present invention to facilitate movement of cargo between respective modules,

FIG. 8 is a schematic view of one form of the present invention illustrating the location of the kingpin utilized to connect the semitrailer of the present invention to an associated tractor.

FIG. 9A is a schematic view illustrating the locking pin structure used in some forms of the present invention.

FIG. 9B is a schematic side view further illustrating the structure of the first module and the location of respective pin holes for accommodating a locking pin as well as respective reflectors disposed to reflect a light beam from the sensor transmitter back to the sensor receiver only when the relative positions of the front and rear modules are in appropriately disposed for engagement in accordance with one form of the present invention.

### DETAILED DESCRIPTION

The retractable trailer in accordance with the present invention is an enclosed trailer, sometimes referred to as a dry van or box trailer, designed to be operated in the inner and outer parts of the city easily as well as on the open road. Driving around the city in a conventional 53 foot trailer can be dangerous because it is too big for the streets, turns and docks. Shorter trailers facilitate urban transportation, however, shorter trailers limit the capacity for freight hauling and accordingly complicate the difficulty of achieving an economic breakeven point. The typically conventional trailer is 53 feet long. Embodiments of the present invention provide a maximum overall trailer length of 53 feet and a minimum length of 32 feet as well as an intermediate overall length of 45 feet. This invention combines a straight box truck with a tractor trailer. The present invention is not a flatbed trailer that is equipped to haul containers or any other flatbed loads. An object of at least some embodiments is to provide apparatus that can be easily operated by one person.

The common issues with trailers involving locking pins and locking handles are that the pins are hard to lock in the open position because they are spring loaded. Therefore the pins always want to jump back into place before you move the truck. I have solved this issue by creating a locking handle lock which holds the handle in place then releases it automatically when set in the desired location by using a sensor securing the trailer in place.

It is important for the operator to know the current trailer length at all times. This determination may in some cases require 2 people. Embodiments of the present invention include a display to indicate the current trailer length and thus do not require more than one person to operate the apparatus. The display in some embodiments utilizes a sight glass window that provides a trailer length indication to the operator. That indication is visible to the driver with the use of the driver side mirror. Embodiments of the present invention also include weather proofing, such as a tarp, to protect the freight from the rain and snow. Embodiments of the present invention also have a ramp in the inside to make moving freight between the front module and rear module easy. Accordingly, the trailer in accordance with the present invention essentially provides the owner with the equivalent a fleet of 3 trailers in a single trailer. Thus, the trailer in accordance with the present invention provides driving versatility as well as an accommodations for full truck loads.

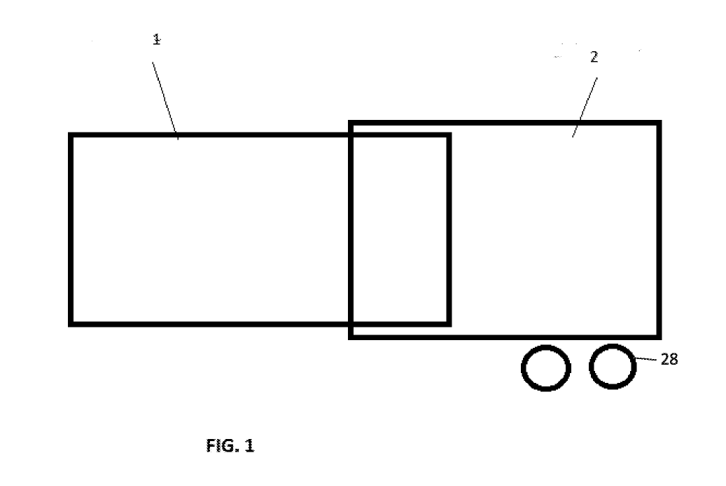

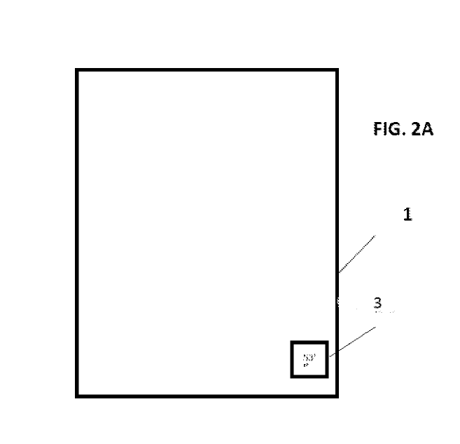

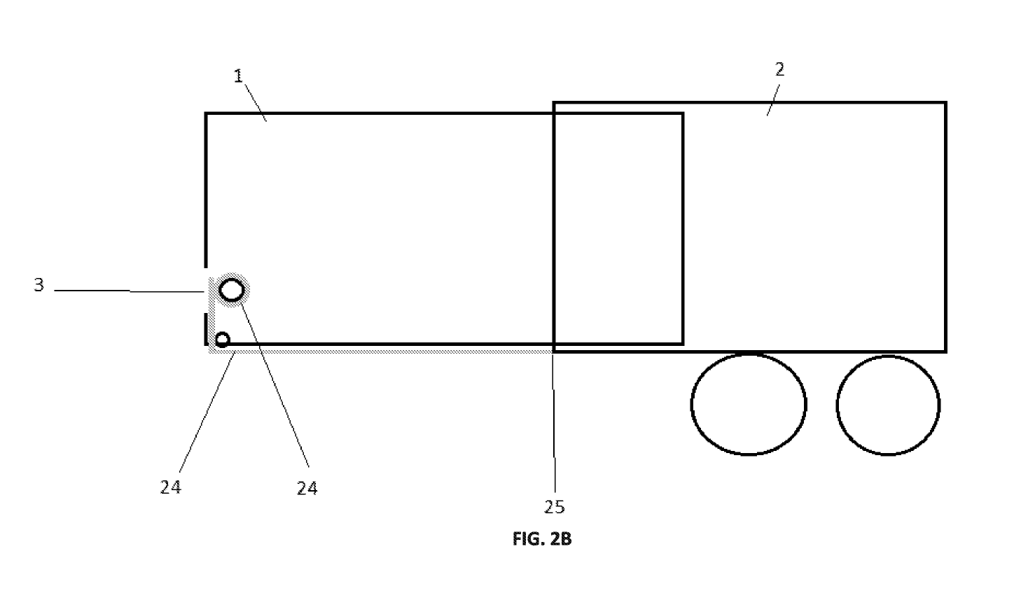

The trailer in accordance with the present invention is made up of two modules as shown in FIG. 1. The front module 1 connects the tractor to the trailer and insert into the rear module 2. The rear module 2 is the part that is adjusted horizontally back and forth with respect to the front module 1. The front module 1 and rear module 2 each holds freight. The rear module 2 is supported by wheels 28. On the front of the front module 1 there is a sight glass window 3 shown in FIG. 2A. The sight glass window 3 is a small window on the front of the front module 1. More particularly, the window 3 in some embodiments is on the left (the driver's side) of the front module 1. It is used to view the tape 24 that indicates the exact overall length of the trailer. The tape 24 is spring loaded is similar in construction to a conventional measuring tape and is visible to the driver through the sight glass window 3. The tape 24 is connected to the rear module 2 at the bottom left. When the rear module 2 moves with respect to the front module the tape 24 is extended or recoiled. Accordingly, the sight glass window 3 displays the exact length of the trailer and this display is visible from the driver's side mirror. In alternative embodiments a linear position sensor may be employed and a display may be disposed in the interior of the tractor. Such linear position sensors are made by various manufacturers including the Novotechnik Division of the Siedle Group in Southborough, Mass. and National Instruments Corporation of Austin, Tex.

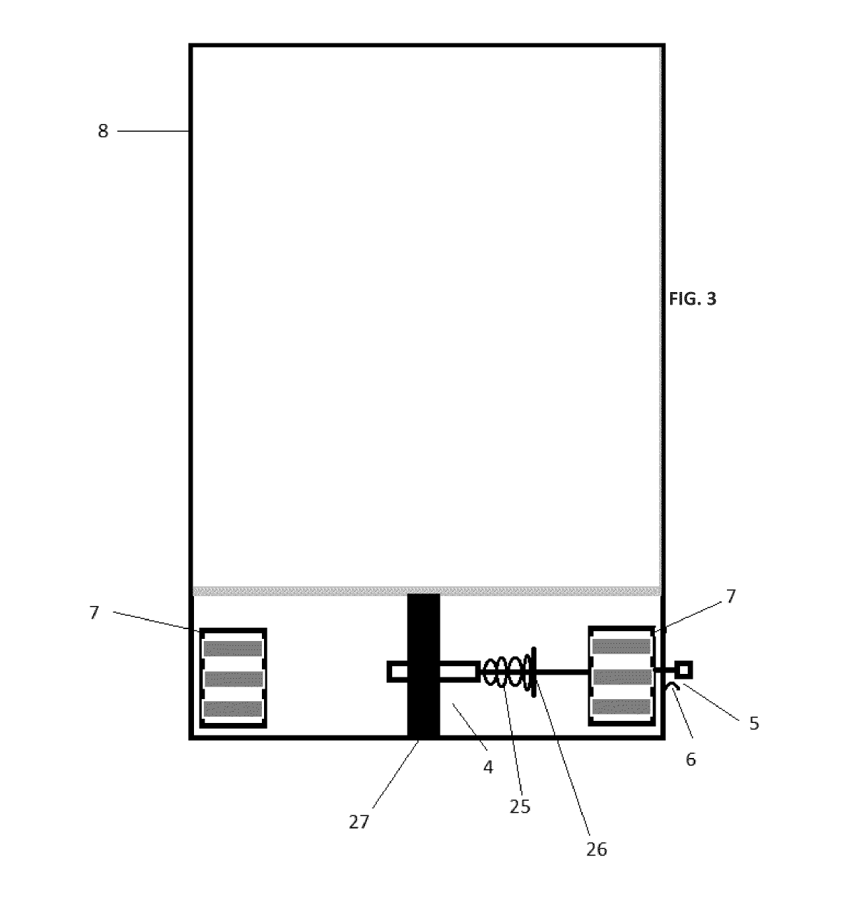

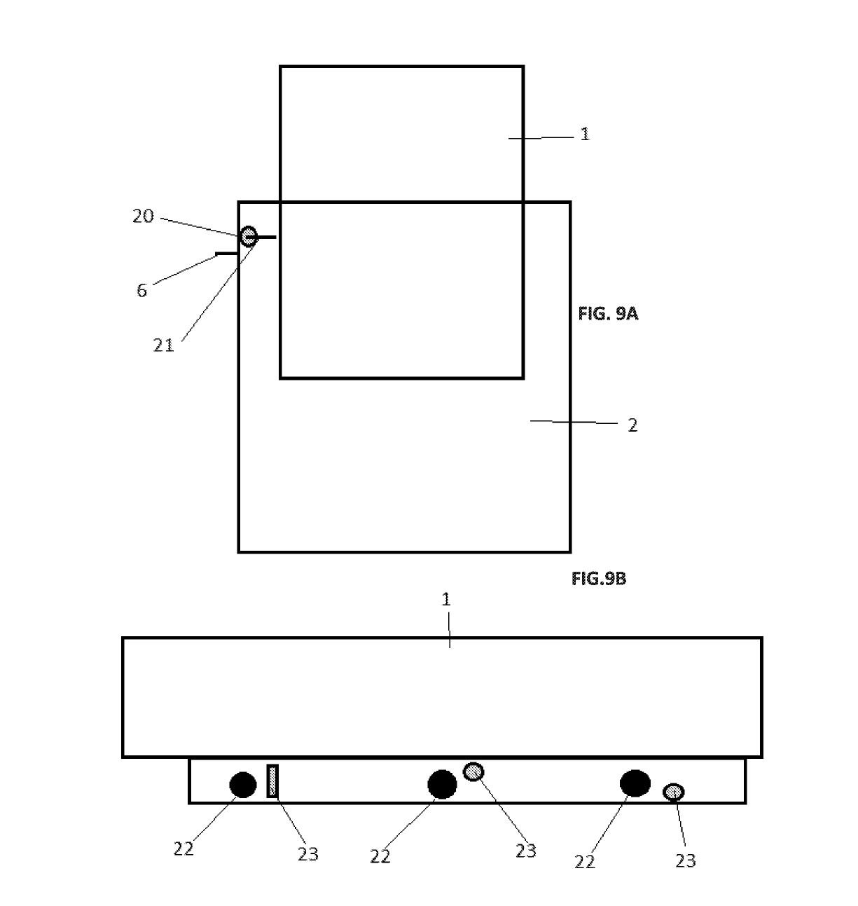

To secure the respective modules of the trailer locking pins 4 are used with pin holes 22 as shown in FIGS. 3 and 9B. The locking pins 4 when inserted into the pin holes 22 prevents relative motion of the modules. To prevent unintentional insertion of the spring loaded pins into the apparatus also includes a pin handle lock 6. The pin handle lock 6 holds the locking pin handle 5 in place to enable movement of the the rear module 2 to a desired overall length. The locking handle pins 4 are located under the rear module 2. The pin holes 22 are located under the front module 1 on the frame bar 27. To assist the driver a sensor 20 with reflectors 23 as shown in FIGS. 9A and 9B. The sensor 20 is connected to the locking pin handle lock 6 and automatically releases the locking pin handle 5 when the desire location is reached. The locking pins 4 are spring loaded 25 and goes in the designated pin hole 22 when the locking pin handle 5 is released by the sensor 20 which in one form of the present invention is a diffuse-reflective photoelectric sensor. One such sensor is manufactured by Omron Industrial Automation having a place of business in Kyoto, Japan. The sensor 20 includes a light beam transmitter that when aligned with one of three reflectors positioned on the trailer at locations corresponding to respect overall trailer lengths of 32 feet, 45 feet and 53 feet reflects a light beam to a receiver on the sensor 20. When reflected in this manner the sensor triggers a solenoid to release the locking pin handle lock 6. This releases the locking pins handle 5 whereby the spring 25 pushes the locking pin 4 in the pin hole 22.

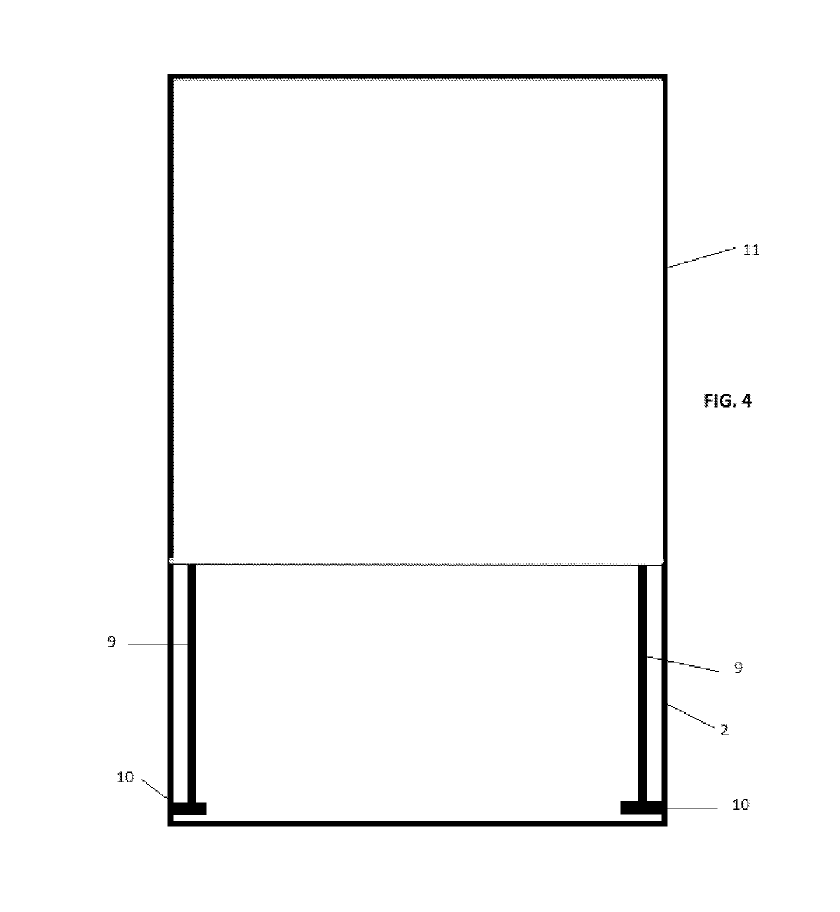

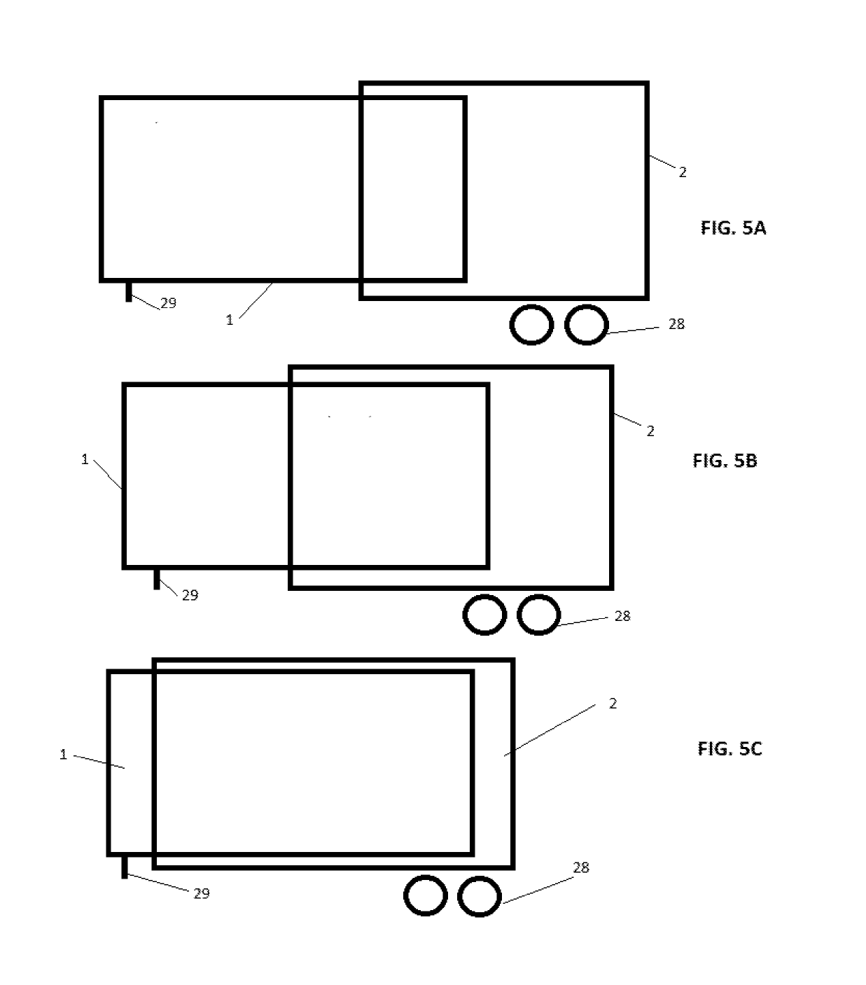

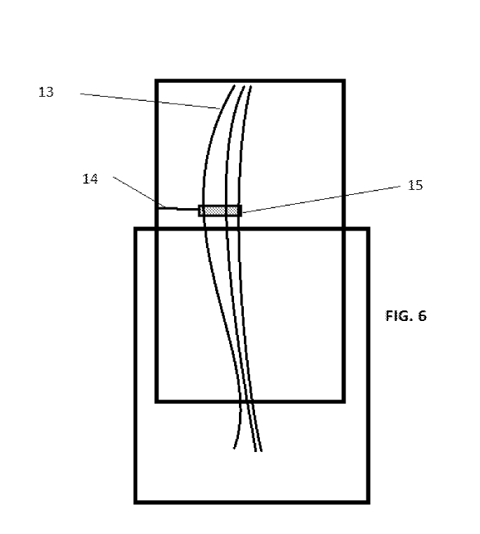

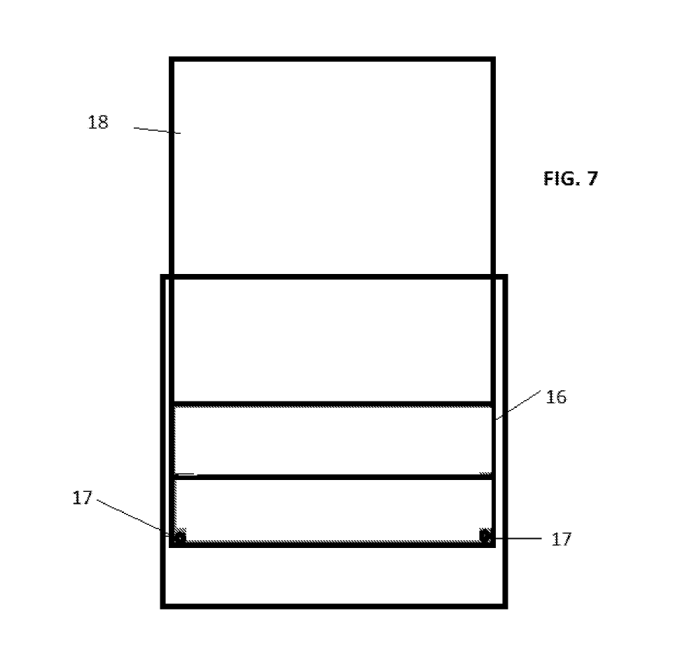

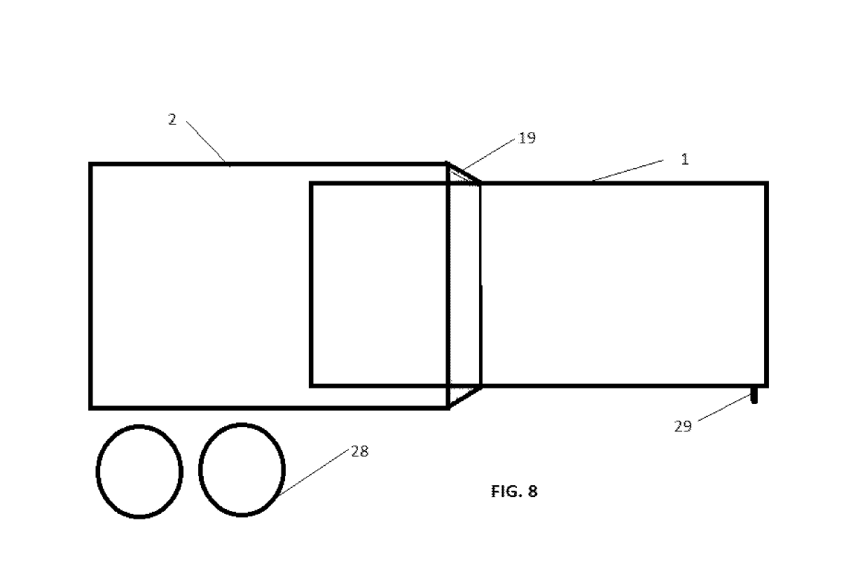

The sensor 20 indicates which pin holes 22 are the correct one. The reflectors 23 are staggered so that the sensor 20 can be adjusted to aim for the appropriate reflector 23 as shown in FIGS. 9A and 9B. In case of an emergency or malfunction the apparatus includes emergency stops 10. The emergency stops 10 stop the rear module 2 from detaching from the front module 1 and are located on the front module rails 9. The front module rails 9 slide on the tracks 7 to help move the rear module 2 easier as shown in FIGS. 3 and 4. The trailer in accordance with one form of the present invention may varied to any one of 3 possible lengths as shown in FIGS. 5A, 5B and 5C. The apparatus also includes a system to keep the air and electric lines 13 off the ground. The air and electric lines 13 are retained in a rubber holder 15 with a retractable spring 14. When the rear module 2 moves backwards the retractable spring 14 expands and when the rear module moves forward the retractable spring 14 retracts as shown in FIG. 6. To help move freight I put a ramp 16 inside on the front module 1. The ramp 16 also has legs 17 to help balance large freight, so it is not on a declining floor as shown in FIG. 7. In FIG. 8 includes a tarp lining 19 designed to prevent water or snow from entering inside of the truck where the freight is. The tarp lining 19 is attached to the outside of the front module 1 and the inside of the rear module 2 and is sealed for weather proofing. In conclusion I have invented a fully enclosed trailer non flatbed used for moving freight around the inner and outer parts of the city with the capacity of a 53 foot trailer also with the versatility of a 32 foot trailer.

The invention will be better understood by reference to the following listing of the elements referred to herein:

1. Front module of trailer which includes the kingpin 29 which connects the trailer to the tractor. The tractor moves the front module back and/or forth with the trailer brakes set to adjust the length of the trailer.

2. Rear module of the trailer known also known as the rear module. The rear module includes a rear tandem that supports the trailer. The rear module includes the locking system that locks the front and rear modules together.

3. Length sight window through which the tape 24 is visible to indicate the current overall length of the trailer. This is color coded and designed so the driver can see the display in the driver's side mirror. When green the pins will be released automatically by virtue of the sensors 20. When red, the front and rear modules are not properly registered and no locking pin is disposed in registered relationship with an aperture.

4. Locking pins secure the front module to the rear module for safe travel. The locking pins are spring loaded to bias the locking pins into locking engagement when the lock is released.

5. Locking pin handle that facilitates the ability of the driver to move respective locking pins in and out of the locked position.

6. Locking pin detent used to secure the handle in the open position. The locking pin detent gives the front module the ability to move freely to get to the desired relative position of the front module with respect to the rear module. The detent automatically release locking pin when the optimum position is achieved.

7. Rollers that engage the front module rails 9 to facilitate relative motion between the front and rear modules. The rollers are on the front module so that the rear module can move back and forth over them

8. Rear module floor disposed under the front module floor.

9. Front module rails that support the rollers to facilitate relative movement between the front and where modules.

10. Emergency stops that prevent detachment rear module from the front module.

11. Front module floor sits above the rear module floor. It is the main floor used for freight.

13. Air and electric lines extending between front and rear modules.

14. Retractable springs on the side of the trailer that pulls the air and electric lines to avoid damage. When the total trailer is size is reduced the spring retracts. When the trailer size is extended the springs extend.

15. Air lines and electrics holder that attaches to a retractable spring coil.

16. Ramp that makes transferring freight from rear module to front module and vice versa more accessible.

17. Ramp legs provided in case any freight is hanging off the front module by a couple of inches the legs will support the ramp so inclination that might cause the freight to fall over and be damaged.

18. Trailer floor

19 Tarp inner lining for weather proofing

20. Sensor that sends a photoelectric signal to one of the reflectors which cause release of a pin locking handle lock. The sensor is adjustable to respond to the desired reflector representative of a desired trailer length.

21. Light beam that operates photoelectric apparatus.

22 Pin holes that are registered other pinholes when the overall length of the trailer is 32′, 45′ or 53′ to allow a locking pin to go through to prevent relative movement between the front and rear modules.

23. Reflector that reflects the signal back to the sensor.

24. Tape having indicia similar to a tape measure used to indicate relative positions of front and rear modules.

25. Springs use to bias pins into engagement with pin holes.

26. Washer that springs push against to bias the pins into holes.

27. Frame bar with pin holes.

28 Wheels supporting rear module.

29 Kingpin for engaging fifth wheel on the tractor

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed:

1. A semi-trailer for use with an associated tractor which comprises:
a parallelpiped shaped van having front and rear axially elongated parallelepiped shaped modules,
said rear axially elongated parallelepiped shaped module having generally planar first and second spaced opposed sides, a generally planar top and a generally planar bottom disposed in spaced opposed relationship, and running gear comprising a plurality of rotatably mounted wheels fixed thereto;
said front axially elongated parallelepiped module having generally parallel planar first and second spaced opposed sides, a generally planar top and a generally planar bottom disposed in spaced opposed relationship, and a generally planar front disposed in generally perpendicular relationship to and engaging said first and second spaced opposed sides as well as said top and bottom, said front axially elongated parallelepiped module being dimensioned and configured for telescoping axial movement with respect to said rear axially elongated parallelepiped module between a first position in which the overall length of the telescoping first and second axially elongated parallelepiped modules is a first dimension and a second position wherein the overall length of the telescoping first and second axially elongated parallelepiped modules is a second dimension that is greater then said first dimension, said front axially elongated parallelepiped module including a king pin for engaging an associated fifth wheel on an associated tractor.

2. The semi-trailer as described in claim 1 wherein said kingpin is proximate to a part of said front module that is most remote from said rear module.

3. The semi-trailer as described in claim 1 wherein said front module is dimensioned to telescope within said rear module.

4. The semi-trailer as described in claim 1 further including a display indicating the relative positions of said first and second modules.

6. The semi-trailer as described in claim 1 further including a plurality of locking pins dimensioned and configured for engaging said first and second modules simultaneously whereby the relative positions of said first and second modules will not change.
